(19) United States
(12) Patent Application Publication
(10) Pub. No.: US 2025/0253944 A1
(43) Pub. Date: Aug. 7, 2025

(54) SYSTEMS AND METHODS FOR SENSING FIBER OPTIC ISSUES IN AN OPTICAL NETWORK

(71) Applicant: Verizon Patent and Licensing Inc., Basking Ridge, NJ (US)

(72) Inventors: Jun Shan Wey, Sammamish, WA (US); Denis A. Khotimsky, Westborough, MA (US); Gregory K. Sherrill, Herndon, VA (US); Tiejun J. Xia, Richardson, TX (US)

(21) Appl. No.: 18/430,831

(22) Filed: Feb. 2, 2024

(51) Int. Cl. H04B 10/077; H04J 14/08

(52) U.S. Cl. CPC H04B 10/0773; H04J 14/08

(57) ABSTRACT

A method for monitoring an optical distribution network (ODN) in a passive optical network (PON), comprises establishing at least one data channel between an optical line terminal (OLT) and at least one optical network unit (ONU). The at least one ONU receives a live data traffic signal on at least one of the at least one data channel. The at least one ONU monitors the live data traffic signal for one or more abnormalities. The at least one ONU transmits an alert to the OLT when one or more abnormalities is detected.

### BACKGROUND

A Passive Optical Network (PON) system is an optical access network that is typically based on a point-to-multipoint (P2MP) optical fiber topology, known as an optical distribution network (ODN). An ODN uses fiber and passive components, such as splitters and combiners. A PON system uses the ODN to provide connectivity between a number of central nodes and a number of user nodes using bi-directional wavelength channels. A PON typically includes an optical line terminal (OLT) at one end of the network, and multiple optical network units (ONUs) near the end users of the network. Optical signals are transmitted from the OLT via an optical fiber of the network and transmitted to each of multiple premises via one or more unpowered optical splitters. Use of the unpowered optical splitters attenuates the optical signals such that the signal strength decreases relative to noise and interference over the optical fiber(s) of the network.

In a single-channel time-division multiplexed (TDM) PON system, each ONU may operate over a single fixed wavelength channel associated with a particular OLT channel termination (CT) over a single ODN. In a time and wavelength division multiplexed (TWDM) PON system, an ONU may operate on a plurality of wavelength channels, one wavelength channel at a time. Each wavelength channel may be associated with its own OLT CT and a plurality of wavelength channels may be multiplexed over a single optical data network.

Identifying fiber optic faults or issues in a PON has proven challenging. Known fiber sensing methods, using, for example, optical time domain reflectometry (OTDR) typically cannot distinguish fault locations beyond the first splitter in a PON, which makes diagnosing branch fiber issues problematic.

### BRIEF DESCRIPTION OF THE DRAWINGS

FIG. 1 illustrates an exemplary environment in which systems and methods described herein may be implemented;

FIG. 2A is a graph depicting a fiber sensing channel in a TDM implementation consistent with embodiments described herein;

FIG. 2B is a graph depicting a fiber sensing channel in a first TWDM implementation consistent with embodiments described herein;

FIG. 3 is a graph depicting a fiber sensing channel in a second TWDM implementation consistent with embodiments described herein;

FIG. 4 is a diagram illustrating exemplary components of a device that may be included in one or more of the devices described herein;

FIG. 5A and 5B depict flow diagrams illustrating a process for monitoring a PON system for fiber damage issues consistent with implementations described herein;

FIG. 6 is a flow diagram illustrating a process for handling identified trunk fiber issues, consistent with implementations described herein; and

FIG. 7 is a flow diagram illustrating a process for proactively alerting a PON system regarding possible fiber optic issues that require monitoring, consistent with implementations described herein.

### DETAILED DESCRIPTION OF EXAMPLE EMBODIMENTS

The following detailed description refers to the accompanying drawings. The same reference numbers in different drawings may identify the same or similar elements. The following detailed description does not limit the invention as claimed.

Embodiments described enable efficient and accurate identification of issues relating to the performance of optical fibers within a passive optical network (PON). Consistent with implementations described herein, a PON is configured to include a dedicated fiber sensing channel between a central office and at least one optical network unit (ONU). Concurrently with live data traffic handling, the ONU may monitor a signal provided on the dedicated fiber sensing channel to identify possible issues that may affect performance. For example, the ONU may monitor the fiber sensing channel for changes in state of polarization or variations in phase that are indicative of adverse environmental issues, such as those caused by construction, weather, seismic events, etc. In the event an issue is identified, the system may issue notifications to network monitoring systems and personnel. In some implementations, such ONU-based dedicated fiber sensing channel processing may be performed in conjunction with distributed fiber optic sensing (DFOS) processing at the central office to further enhance fiber optic issue identification and handling.

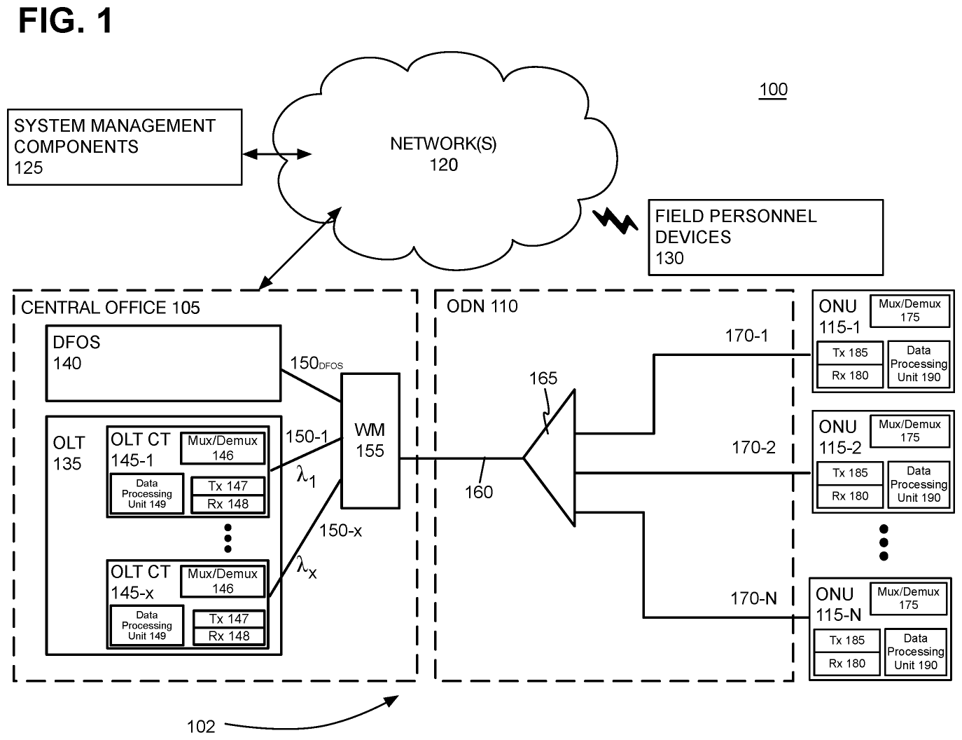

FIG. 1 is a block diagram illustrating an exemplary environment 100 in which systems and methods described herein may be implemented. As shown in FIG. 1, environment 100 may include a PON system 102 that includes central office 105, an ODN 110, and a plurality of ONUs 115-1 to 115-N (also referred to as ONUs 115, or individually or generally as ONU 115). Environment 100 further includes backend network(s) 120, system management components 125, and field personnel devices 130.

Central office 105 may provide interconnection between a PON and transport networks (e.g., metro, long haul) that provide communications connectivity to ONUs 115. As shown in FIG. 1, central office 105 includes an OLT 135 and a DFOS system 140 each connected to a wavelength multiplexer/demultiplexer (WM) 155 via channel attachment fibers 150-1 to 150-x and 150_{DFOS}, respectively, that correspond to particular channel wavelengths. Channel attachments fibers 150-1 to 150-x and 150_{DFOS} may be referred to collectively as channel attachment fibers 150, or individually or generally as channel attachment fiber 150.

In TDM implementations, OLT 135 may include a single channel termination (CT) 145 and may be coupled to WM 155 via a single channel attachment fiber 150, while in TWDM implementations, OLT 135 may include a plurality (e.g., four) of OLT channel terminations (CTs) 145-1 to 145-x, each corresponding to a particular channel wavelength, and may be coupled to WM 155 via a corresponding plurality of channel attachment fibers 150. OLT CTs 145-1 to 145-x may be referred to collectively as OLT CTs 145, or individually or generally as OLT CT 145. OLT CTs 145 may correspond, for example, to optical blades or cards associated with optical signals carried via a PON, such as ODN 110, to ONUs 115. OLT CTs 145 may communicate with the customer premises via ODN 110 to provide data and/or services to the customer premises.

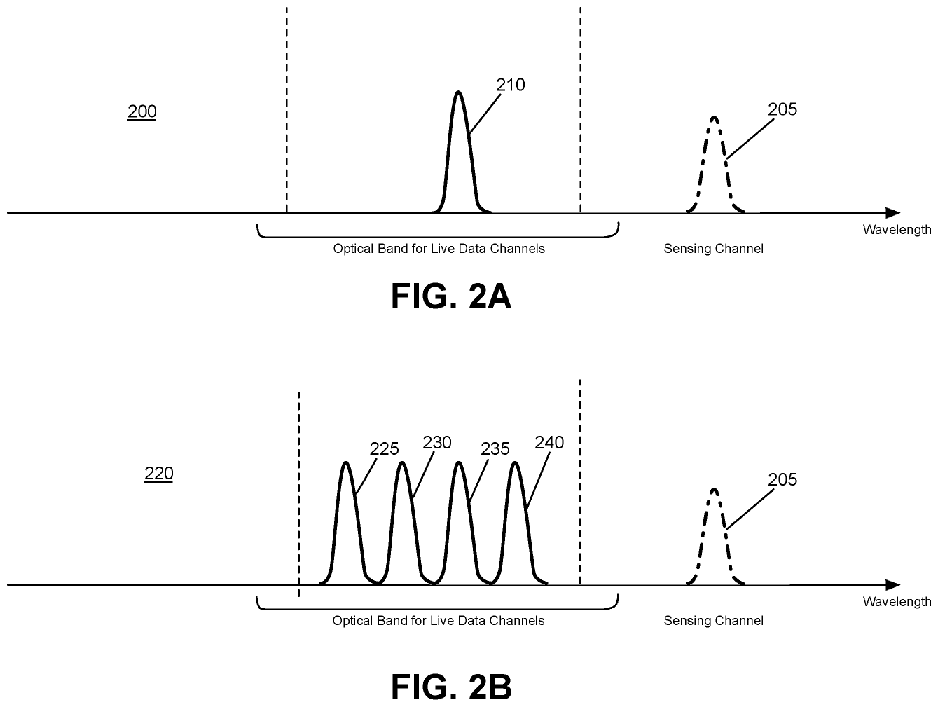

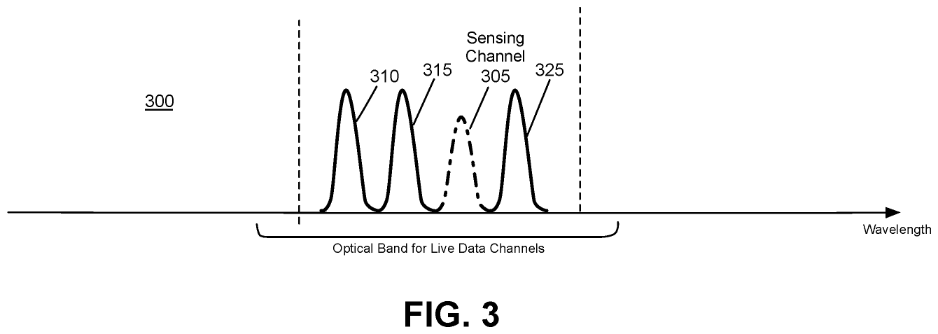

Consistent with implementations described herein, OLT 135 may be configured to establish a dedicated fiber sensing channel on ODN 110 along with or in addition to live data channels. As described below, optical receivers and data processing in ONUs 115 may be configured to monitor the fiber sensing channel to identify potential fiber issues without requiring taking down ONU 110 from live customer data traffic. In a first implementation, the dedicated fiber sensing channel may be provided as a discrete out-of-band channel spaced apart from the live data channels. The sensing channel is well isolated from the data channels to avoid crosstalk between the two different types of channels. FIG. 2A is a graph 200 depicting such a fiber sensing channel 205 in a TDM implementation. As shown, fiber sensing channel 205 is provided well apart from the wavelength of live data channel 210 to avoid crosstalk on the optical fiber(s). FIG. 2B is a graph 220 depicting fiber sensing channel 205 in a TWDM implementation. As shown, fiber sensing channel 205 is provided well apart from the wavelength of live data channels 225, 230, 235, and 240 to avoid crosstalk on the optical fiber(s).

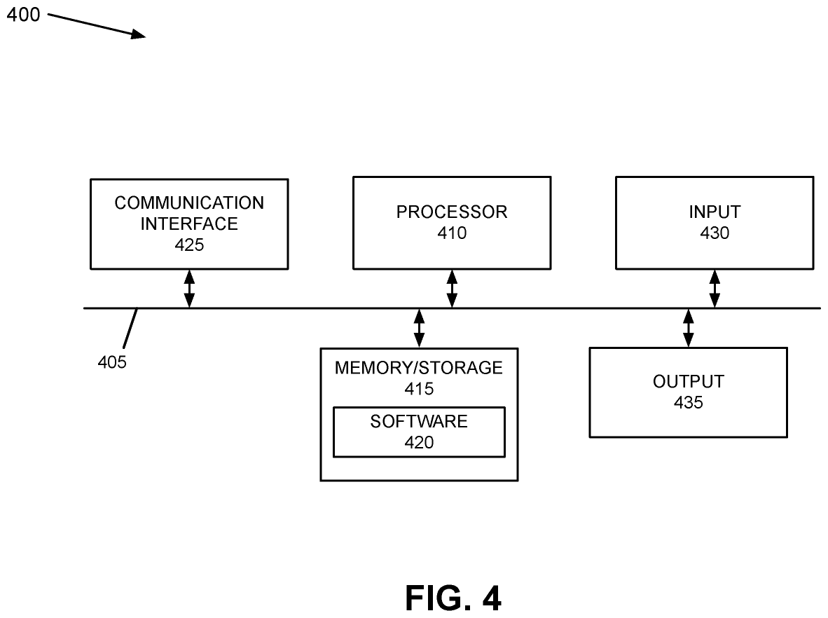

In a second implementation, one of the live data channels in a TWDM implementation may be replaced with an in-band fiber sensing channel. FIG. 3 is a graph 300 depicting in-band fiber sensing channel 305 replacing the third of the four live data channels, leaving live data channels 310, 315, and 325 active.

Returning to FIG. 1, each of OLT CTs 145 includes a includes a multiplexer/demultiplexer 146, an optical transmitter 147, an optical receiver 148, and a data processing unit 149 for transmitting, receiving, and processing optical signals to/from attachment fibers 150.

Each optical transmitter 147 may be configured to output a modulated light signal having a corresponding optical wavelength λ. Consistent with implementations described herein. each optical receiver 148 may include a coherent receiver. Data processing unit 149 may include a Digital Signal Processing (DSP) or Automatic Gain Control (AGC) unit. Coherent receivers may coherently detect, and analog-to-digital convert modulated light signals of a particular wavelength λ. The coherent receiver passes the resulting digital signals to the data processing unit 149 for signal processing.

Consistent with implementations described herein, DFOS system 140 may generate a sensing signal on channel attachment fiber 150_{DFOS} corresponding to the dedicated fiber sensing channel wavelength. The sensing signal is then multiplexed by WM 155 and distributed to trunk fiber 160. Consistent with the implementations described above in relation to FIGS. 2A and 2B, DFOS system 140 may generate its sensing signal using an out-of-band wavelength. Consistent with the implementation described in FIG. 3, DFOS system 140 may generate its sensing signal using an unused, in-band wavelength.

DFOS system 140 may include components configured to monitor ODN 110 for particular effects that indicate potential issues. For example, DFOS system 140 may include an optical transmitter, an optical receiver, and digital signal processing (DSP) components for detecting and evaluating DFOS signals for particular optical artifacts, such as Rayleigh, Brillouin, and Raman backscattering, etc. DFOS system 140 may further include a risk assessment function element for receiving the processed DFOS signal data and determining whether the signal data is indicative of a fiber issue. In the event that an issue is identified, DFOS system 140 may transmit an alert to one or more system management components 125 and/or field personnel devices 130 via backend network(s) 120. For example, field personnel devices 130 may include mobile devices coupled to backend network(s) 120 via a wireless mobile network, such as a public land mobile network (PLMN).

Functions of OLT CTs 145 may be governed by one or more system management components 125 coupled to central office 105 via one or more backhaul network(s) 120. For example, system management components 125 may include a control and management system (CMS) and system orchestrator configured to setup, manage, and monitor PON system 102.

ODN 110 may include a trunk fiber 160 coupled to WM 155 and an optical splitter 165, and a plurality of distribution or branch fibers 170-1 to 170-N (also referred to as distribution fibers 170, or individually or generally as distribution fiber 170) to connect splitter 165 and ONUs 115. Although not depicted in FIG. 1 for simplicity, ODN 110 may include various additional components associated with a PON system 102. For example, ODN 110 may include various passive optical components such as filters, attenuators, etc. ODN 110 may also include multiple “levels” of optical splitters 165 to increase the fanout of the ODN 110. For example, trunk fiber 160 may connect to a first optical splitter 165, and a “feeder” fiber may connect the first optical splitter to a second optical splitter 165. Distribution fibers 170 may be connected to second optical splitter 165. Some implementations may use further levels of splitting.

ONUs 115 include devices to terminate distribution fibers 170 at customer premises. ONUs 115 may demultiplex incoming optical signals into component parts (such as voice telephone, television, and Internet), and provide the signals to user devices in customer premises. ONUs 115 may also transmit outgoing signals from devices in customer premises back to central office 105 via ODN 110.

As described above, each of OLT CTs 145 may be associated with a separate wavelength or range of wavelengths for sending downstream signals. Similarly, ONUs 115 may be associated with separate wavelengths or ranges of wavelengths for sending upstream signals back to central office 105. Consistent with implementations described herein, each of ONUs 115 includes a multiplexer/demultiplexer 175, a coherent optical receiver 180, an optical transmitter 185, and a data processing unit 190. As described in additional detail below, ONUs 115 may be configured to monitor received optical signals for fluctuations in state of polarization (SOP) or phase abnormalities indicative of a risk of damage to an optical fiber within ODN 110. In some implementations, data processing functions and receiver DSP may use or incorporate one or more artificial intelligence (AI) and/or machine learning (ML) algorithms for training of received signal to determine a risk level corresponding to the processed data. As described below, depending on the determined risk level, ONUs 115 may notify or alert OLT 135 and/or one or more system management components 125 regarding the likelihood of an identified fiber optic issue.

Although FIG. 1 illustrates exemplary components of environment 100, in other implementations, environment 100 may include fewer components, different components, differently arranged components, and/or additional components than those depicted in environment 100. Also, functions described as being performed by respective separate components of environment 100 may be performed by a single component, or a single function may be performed by multiple components of environment 100.

Furthermore, in FIG. 1, the depicted particular arrangement and number of components of environment 100 are illustrated for simplicity. In practice, there may be more or fewer central offices 105, ODNs 110, ONUs 115, OLTs 135, or OLT CTs 145 than depicted in FIG. 1. For example, there may be dozens of central offices 105 associated with a network environment, and tens or even hundreds of OLT CTs 110 associated with a single central office 105.

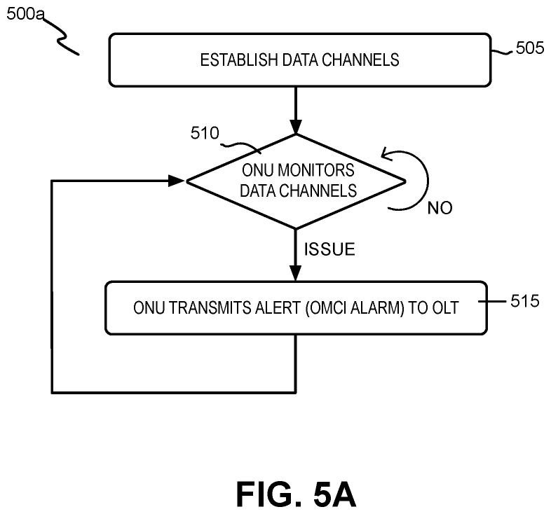

FIG. 4 is a diagram illustrating exemplary components of a device 400 that may be included in one or more of the devices described herein. For example, some or all of the components of device 400 may be included in OLT CTs 145, ONUs 115, system management components 125, and/or field personnel devices 130. As illustrated in FIG. 4, device 400 includes a bus 405, a processor 410, a memory/storage 415 that stores software 420 and other data, a communication interface 425, an input 430, and an output 435. According to other embodiments, device 400 may include fewer components, additional components, different components, and/or a different arrangement of components than those illustrated in FIG. 4 and described herein. Additionally, or alternatively, according to other embodiments, multiple components may be combined into a single component. For example, processor 410, memory/storage 415, and communication interface 425 may be combined.

Bus 405 includes a path that permits communication among the components of device 400. For example, bus 405 may include a system bus, an address bus, a data bus, and/or a control bus. Bus 405 may also include bus drivers, bus arbiters, bus interfaces, clocks, and so forth.

Processor 410 includes one or multiple processors, microprocessors, data processors, co-processors, application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, and/or some other type of component that interprets and/or executes instructions and/or data. Processor 410 may be implemented as hardware (e.g., an ASIC, etc.), a combination of hardware and software (e.g., a SoC, a microprocessor, etc.), may include one or multiple memories (e.g., cache, etc.), etc.

Processor 410 may control the overall operation, or a portion of operation(s) performed by device 400. Processor 410 may perform one or multiple operations based on an operating system and/or various applications or computer programs (e.g., software 420). Processor 410 may access instructions from memory/storage 415, from other components of device 400, and/or from a source external to device 400 (e.g., a system management components 125, etc.). Processor 410 may perform an operation and/or a process based on various techniques including, for example, multithreading, parallel processing, pipelining, interleaving, etc.

Memory/storage 415 includes one or multiple memories and/or one or multiple other types of storage mediums. For example, memory/storage 415 may include one or multiple types of memories, such as random access memory (RAM), dynamic random access memory (DRAM), cache, read only memory (ROM), a programmable read only memory (PROM), a static random access memory (SRAM), a single in-line memory module (SIMM), a dual in-line memory module (DIMM), a flash memory, and/or some other type of memory. Memory/storage 415 may include a hard disk (e.g., a magnetic disk, an optical disk, a magneto-optic disk, a solid state disk, etc.), a Micro-Electromechanical System (MEMS)-based storage medium, a nanotechnology-based storage medium, and/or the like. Memory/storage 415 may include drives for reading from and writing to the storage medium.

Memory/storage 415 may be external to and/or removable from device 400, such as, for example, a Universal Serial Bus (USB) memory stick, a dongle, a hard disk, mass storage, off-line storage, or some other type of storing medium (e.g., a compact disk (CD), a digital versatile disk (DVD), a Blu-Ray disk (BD), etc.). Memory/storage 415 may store data, software, and/or instructions related to the operation of device 400.

Software 420 includes an application or a program that provides a function and/or a process. For example, software 420 may inform the DSP or AGC processing performed by ONU 115 and/or OLT CT 145, etc. Software 420 may also include firmware, middleware, microcode, hardware description language (HDL), and/or other form of instruction. Software 420 may include an operating system.

Communication interface 425 permits device 400 to communicate with other devices, networks, systems, and/or the like. As described above, consistent with implementations described herein, communication interface 425 includes one or multiple optical interfaces. Communication interface 425 may further include one or multiple wired and/or wireless interfaces. Communication interface 425 includes one or multiple transmitters and receivers, or transceivers. Communication interface 425 may operate according to a protocol stack and a communication standard. Communication interface 425 may include one or multiple line cards. For example, communication interface 425 may include processor 410, memory/storage 415, and software 420.

Input 430 permits an input into device 400. For example, input 430 may include a keyboard, a mouse, a display, a touchscreen, a touchless screen, a button, a switch, an input port, speech recognition logic, and/or some other type of visual, auditory, tactile, etc., input component. Output 435 permits an output from device 400. For example, output 435 may include a speaker, a display, a touchscreen, a touchless screen, a light, an output port, and/or some other type of visual, auditory, tactile, etc., output component.

Device 400 may perform a process and/or a function, as described herein, in response to processor 410 executing software 420 stored by memory/storage 415. By way of example, instructions may be read into memory/storage 415 from another memory/storage 415 (not shown) or read from another device (not shown) via communication interface 425. The instructions stored by memory/storage 415 cause processor 410 to perform a process described herein. Alternatively, for example, according to other implementations, device 400 performs a process described herein based on the execution of hardware (processor 410, etc.).

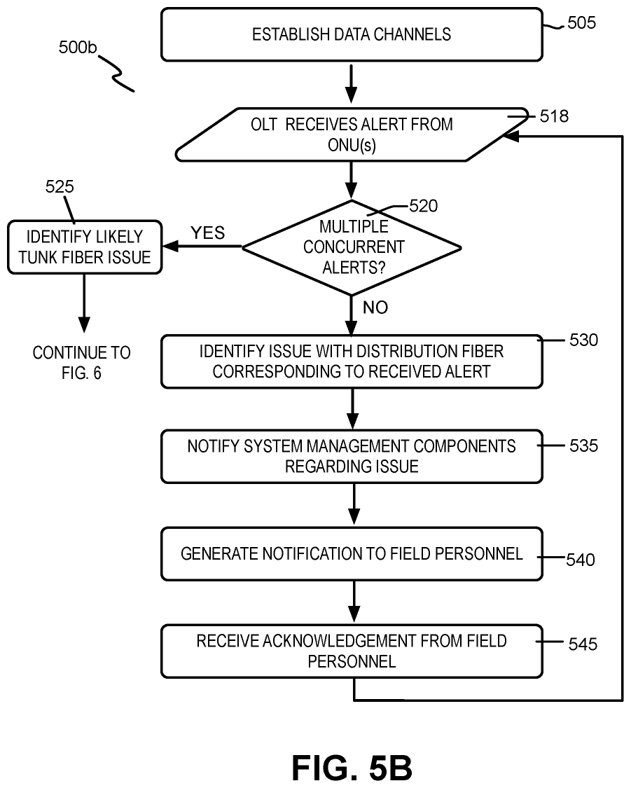

FIG. 5A is a flow diagram illustrating a process 500a for monitoring PON system 102 for fiber damage issues consistent with implementations described herein. In exemplary implementations, process 500a is performed by ONUs 115, although execution may be performed by other devices or a combination of devices in PON system 102. Process 500a may begin by ONUs 115 establishing one or more data channels with OLT 135 (block 505). For example, system management components 125 may transmit instructions to central office 105 that cause OLT 135 to associate one or more OLT CTs 145 with a data channels using one or more wavelengths.

Next, each ONU 115 monitors the data channels for issues or abnormalities (block 510). For example, and as described above, the coherent receiver in ONUs 115 may receive a data signal on one or more of the data channels and the signal may be processed by the DSP or AGC component. The processed signal is then evaluated for variability, such as state of polarization changes and/or phase abnormalities. Such an evaluation may include comparing the processed signal to reference or training data. In some implementations, artificial intelligence or machine learning algorithms may be applied to the processed signal to ascertain a risk level associated with the identified data. Such risk level processing may include analysis of whether variations in the signal indicate a risk of physical issues or damage to the fiber, such as issues caused by environmental events or conditions, such as construction events, seismic conditions, accidental damage, etc.

If one or more ONUs 115 determine that a likely fiber issue (block 510—ISSUE), the detecting ONU 115 transmits an alert to the OLT 135 (block 515). In one implementation, ONU 115 transmits the alert to OLT 135 using an ONU management and control interface (OMCI) Alarm message via an ONU Management and Control Channel (OMCC) provided between ONUs 115 and OLT 135. After transmission of the alert to OLT 135 or if no ONU 115 identifies an issue (block 510—NO), processing returns to block 510 for continued monitoring.

FIG. 5B is a flow diagram illustrating a process 500b for monitoring PON system 102 for fiber damage issues consistent with implementations described herein. In exemplary implementations, process 500b is performed by OLT 135, although execution may be performed by other devices or a combination of devices in PON system 102, consistent with embodiments described herein. As with process 500a described above, process 500b may also begin by OLT 135 establishing one or more data channels with ONUs 115 (block 505).

Next, OLT 135 may receive a fiber issue alert from one or more ONUs 115 (block 518). For example, as described above, one or more of the ONUs associated with OLT 135 may transmit OMCI Alarm messages to OLT 135 indicating a likely issue on its associated distribution fiber 170.

Upon receipt of at least one alert regarding a potential fiber issue from at least one ONU 115, as described above in relation to FIG. 5A, OLT 135 determines whether concurrent or substantially concurrent alerts have been received from multiple ONUs 115 (block 520). Such a determination may be used to identify or inform a likely location of an issue, with multiple concurrent alerts denoting a likely issue with a feeder fiber (including trunk fiber 160) and individual ONU alerts denoting possible issues with a distribution fiber 170 associated with the alerting ONU 115. The relative concurrency of the alerts may be within a predetermined time range of each other, such as within approximately 5 minutes or less, for example, to allow for individual adjacent construction or weather events which may indicate distribution fiber issues in contrast to feeder/trunk fiber issues identified by alerts occurring within approximately 5 minutes of each other.

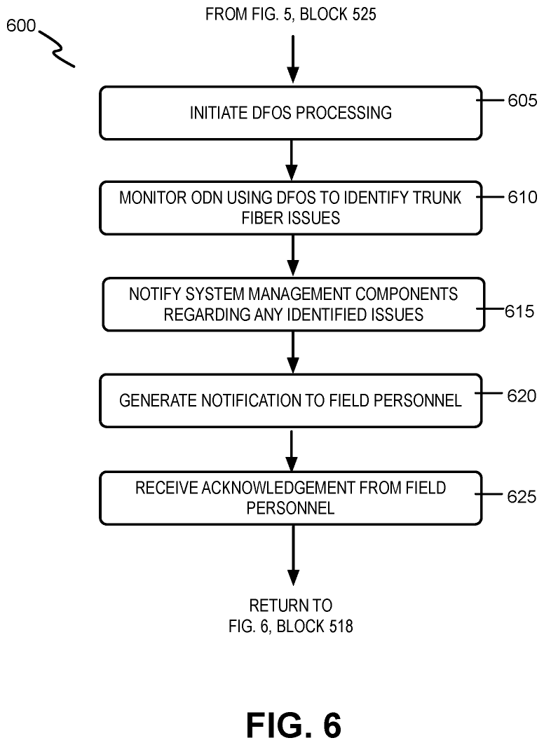

If OLT 135 determines that multiple concurrent events have been received (block 520—YES), OLT 135 may determine that there is an issue with a feeder fiber that is common to the distribution fibers 170 on which the ONUs 115 producing the alerts are connected (block 525). For example, using the example in FIG. 1, alerts produced by ONUs 115-1 and 115-2 may cause the OLT 135 to determine that there is an issue with trunk fiber 160. Processing then continues to process 600 described below in relation to FIG. 6.

However, when OLT 135 determines that multiple concurrent events have not been received (block 520—NO), OLT 135 identifies or determines that there is an issue with the distribution fiber 170 corresponding to the received alert (block 530). In response to determining that an issue exists, OLT 135 notifies one or more system management components 125 regarding the likely issue (block 535). For example, OLT 135 may transmit a notification to a PON control and management system indicating an identification and/or location of the ONU 115 that identified the issue and the distribution fiber associated with the ONU 115. In response, the one or more system management components 125 may generate a notification to a network operations center and/or field personnel devices 130 regarding the issue (block 540). For example, system management components 125 may generate an emergency broadcast via a mobile network to field personnel devices 130 associated with a relevant geographic area corresponding to the identified feeder fiber or distribution fiber. A field personnel device 130 may acknowledge the notification and create a work order to investigate the issue (block 545).

FIG. 6 is a flow diagram illustrating a process 600 for handling identified trunk fiber issues, such as those described above in relation to block 525 of FIG. 5. In exemplary implementations, process 600 is performed by OLT 135, although execution may be performed by other devices or a combination of devices in PON system 102, consistent with embodiments described herein. As shown in FIG. 6, upon determining an identification of a possible trunk fiber issue, OLT 135 may initiate DFOS processing (block 605). For example, OLT 135 may notify DFOS system 140 to initiate DFOS monitoring. In response, DFOS system 140 may begin monitoring ODN 110 and may identify any trunk fiber-related issue as well as the determined location (block 610). For example, DFOS system 140 may generate and transmit a sensing signal on an out-of-band or in-band sensing channel having a defined wavelength, as described above in relation to FIGS. 2A-3. DFOS system 140 may monitor the sensing channel for relevant backscatter (e.g., Rayleigh, Brillouin, and Raman backscattering, etc.) and may identify or determine likely feeder/trunk fiber issues based on the monitoring. In some implementations, DFOS system 140 may be configured to further incorporate ONU alert information into its issue determination process, such as the number of ONUs reporting alerts, the risk level associated with such alerts, etc.

In response to an identification of a feeder/trunk fiber issue, DFOS system 140 may notify one or more system management components 125 regarding the likely issue (block 615). For example, DFOS system 140 (or another component of central office 105) may transmit a notification to a PON control and management system (e.g., included in system management components 125) indicating an identification and/or location of a likely issue. In response, the one or more system management components 125 may generate a notification to field personnel devices 130 regarding the issue (block 620). For example, system management components 125 may generate an emergency broadcast via a mobile network to field personnel devices 130 associated with a relevant geographic area corresponding to the identified trunk fiber 160. A field personnel device 130 may acknowledge the notification and create a work order to investigate the issue (block 625).

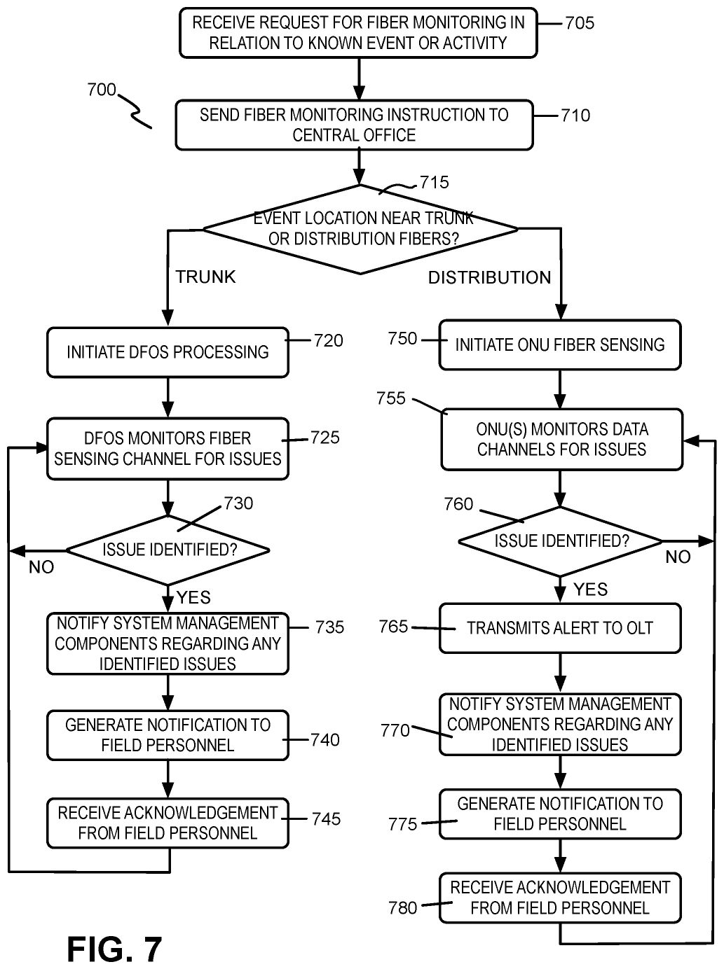

FIG. 7 is a flow diagram illustrating a process 700 for proactively alerting regarding possible fiber optic issues that require monitoring. Process 700 may begin when one or more system management components 125 receive a request for fiber monitoring in relation to a known event or activity, such as a known or future construction event (block 705). For example, a user may initiate a fiber monitoring request via a field personnel device 130 or other device coupled to backend network 120. The request includes a geographic location of the known event or activity.

In response, the system management component 125 (e.g., PON control and management system, orchestrator, etc.) may transmit a fiber monitoring instruction to one or more central offices 105 associated with the geographic location, indicating a request to activate fiber monitoring (block 710). In some implementations, location information may be included to allow central office 105 to selectively activate fiber monitoring for certain OLTs (e.g., if central office contains multiple OLTs). In response, central office 105 may correlate the location of the event or activity to fiber locations within ODN 110 to identify whether the activity is near a trunk fiber 160 or any distribution fibers 170 (block 715). In some implementations, such processing may be performed by DFOS system 140, although in other implementations, other components at central office 105 or system management component(s) 125 may perform this correlation.

In any event, if it is determined that the location of the event or activity is near or proximate to trunk fiber 160 (block 715—TRUNK), central office 105 may initiate DFOS processing (block 720). In response, DFOS system 140 may begin monitoring ODN 110 (block 725) and may determine whether issues are identified with respect to trunk fiber 160 (block 730). Consistent with implementations described herein, DFOS monitoring may be performed in a manner similar to that described above in relation to FIG. 5B.

If no issues are found (block 730—NO), processing returns to block 725 for continued DFOS processing. However, if DFOS system 140 identifies one or more issues, DFOS system 140 may notify one or more system management components 125 regarding any identified or possible issues (block 735). For example, DFOS system 140 may transmit a notification to a PON control and management system (e.g., included in system management components 125) indicating an identification and/or location of a likely issue. In response, the one or more system management components 125 may generate a notification to field personnel devices regarding the issue (block 740). For example, system management components 125 may transmit an alert to field personnel devices 130 associated with a relevant geographic area. A field personnel device 130 may acknowledge the notification and create a work order to investigate the issue (block 745). Processing then returns to block 725 for continued DFOS monitoring.

If it is determined that the location of the event or activity is not near or proximate to trunk fiber 160 (block 715—DISTRIBUTION), central office 105 may initiate ONU fiber sensing at locations proximate to the event or activity (block 750). In response, each proximate ONU 115 monitors live data signals in one or more data channels for issues or abnormalities (block 755), in the manner described above in relation to FIG. 5A. For example, ONU 115 may identify abnormal state of polarization or phase variations in received live data signals and may determine a risk level associated with the identified abnormalities.

If it determined that a likely fiber issue has occurred (block 760—YES), the detecting ONU 115 transmits an alert to the OLT 135 (block 765), e.g., using the OMCI Alarm message. If ONU 115 does not identify an issue (block 760—NO), processing returns to block 755 for continued monitoring. In response to receipt of an issue from at least one ONU 115, OLT 135 notifies one or more system management components 125 regarding the likely issue (block 770). For example, OLT 135 may transmit a notification to a PON control and management system indicating an identification and/or location of the likely issue. In response, the one or more system management components 125 may generate a notification to field personnel devices 130 regarding the issue (block 775). A field personnel device 130 may acknowledge the notification and create a work order to investigate the issue (block 780). Processing then returns to block 725 for continued ONU live data monitoring.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while a series of blocks have been described with respect to FIGS. 5-7, the order of the blocks and/or signals may be modified in other implementations. Further, non-dependent blocks may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code—it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

It should be emphasized that the terms “comprises”/“comprising” when used in this specification are taken to specify the presence of stated features, integers, steps or components but does not preclude the presence or addition of one or more other features, integers, steps, components or groups thereof.

The term “logic,” as used herein, may refer to a combination of one or more processors configured to execute instructions stored in one or more memory devices, may refer to hardwired circuitry, and/or may refer to a combination thereof. Furthermore, a logic may be included in a single device or may be distributed across multiple, and possibly remote, devices.

For the purposes of describing and defining the present invention, it is additionally noted that the terms “substantially” or “approximately” are utilized herein to represent the inherent degree of uncertainty that may be attributed to any quantitative comparison, value, measurement, or other representation. The terms “substantially” or “approximately” are also utilized herein to represent the degree by which a quantitative representation may vary from a stated reference without resulting in a change in the basic function of the subject matter at issue.

To the extent the aforementioned embodiments collect, store, or employ personal information of individuals, it should be understood that such information shall be collected, stored, and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential to the embodiments unless explicitly described as such. Also, as used herein, the article “a” is intended to include one or more items. Further, the phrase “based on” is intended to mean “based, at least in part, on” unless explicitly stated otherwise.

What is claimed is:

1. A method for monitoring an optical distribution network (ODN) in a passive optical network (PON), comprising:
establishing at least one data channel between an optical line terminal (OLT) and at least one optical network unit (ONU);
receiving, by the at least one ONU, a live data traffic signal on at least one of the at least one data channel;
monitoring, by the at least one ONU, the live data traffic signal for one or more abnormalities; and
transmitting, by the at least one ONU, an alert to the OLT when one or more abnormalities is detected.

2. The method of claim 1, wherein the PON comprises a time division multiplexing (TDM) PON or a time and wavelength division multiplexing (TWDM) PON.

3. The method of claim 1, wherein each of the at least one ONU comprises a coherent receiver and a data processing unit, and
wherein monitoring the live data traffic signal for one or more abnormalities comprises:
receiving the live data traffic signal by the coherent receiver, and
processing the received live data traffic signal by the data processing unit to identify the one or more abnormalities.

4. The method of claim 3, wherein the data processing unit comprises at least one of a digital signal processor (DSP) or an automatic gain control (AGC) unit.

5. The method of claim 3, wherein processing the received live data traffic signal by the data processing unit to identify the one or more abnormalities further comprises:
performing, by the data processing unit, a risk assessment analysis to determine a risk level associated with the identified one or more abnormalities; and
transmitting, by the at least one ONU, the alert to the OLT based on the determined risk level.

6. The method of claim 5, wherein the risk assessment analysis may use or incorporate one or more artificial intelligence (AI) and/or machine learning (ML) algorithms.

7. The method of claim 1, wherein the one or more abnormalities comprise at least one of a state of polarization or a phase variation of the sensing signal.

8. The method of claim 1, further comprising:
determining, by the OLT, that alerts have been received from multiple ONUs, and
initiating distributed fiber optic sensing (DFOS) processing to identify whether a trunk fiber issues has occurred.

9. The method of claim 7, further comprising:
determining whether the alerts from the multiple ONUs are received substantially concurrently or within a predetermined time period; and
initiating DFOS processing when the alerts from the multiple ONUs are received substantially concurrently or within the predetermined time period.

10. The method of claim 1, further comprising:
notifying one or more system management components regarding the alert,
wherein the notification includes at least the location of the ONU and associated distribution fiber.

11. The method of claim 10, further comprising:
generating, by the one or more system management components, a notification to one or more field personnel devices regarding the alert.

12. A system for monitoring an optical distribution network (ODN) in a passive optical network (PON), comprising:
an optical line terminal (OLT);
a plurality of optical network units (ONUs),
wherein the OLT is configured to establish at least one data channel with the plurality of ONUs;
wherein the OLT is configured to transmit a live data traffic signal on at least one of the at least one data channel to at least one of the plurality of ONUs;
wherein each of the plurality of ONUs is configured to monitor the live data traffic signal for one or more abnormalities; and
wherein each of the plurality of ONUs is configured to transmit an alert to the OLT when one or more abnormalities is detected.

13. The system of claim 12, wherein each of the plurality of ONUs comprises a coherent receiver and a data processing unit, and
wherein the ONUs configured to monitor the live data traffic signal for one or more abnormalities are further configured to:
receive the live data traffic signal by the coherent receiver, and
process the received live data traffic signal by the data processing unit to identify the one or more abnormalities.

14. The system of claim 13, wherein the ONUs configured to process the received live data traffic signal by the data processing unit to identify the one or more abnormalities further are further configured to:
perform a risk assessment analysis to determine a risk level associated with the identified one or more abnormalities; and
transmit the alert to the OLT based on the determined risk level.

15. The system of claim 12,
wherein the OLT is further configured to determine that alerts have been received from multiple of the plurality of ONUs, and
wherein the OLT is configured to initiate distributed fiber optic sensing (DFOS) processing to identify whether a trunk fiber issues has occurred.

16. The system of claim 15,
wherein the OLT is further configured to determine whether alerts from the multiple ONUs are received substantially concurrently or within a predetermined time period, and
wherein the OLT is configured to initiate DFOS when the fiber sensing alerts from the multiple ONUs are received substantially concurrently or within the predetermined time period.

17. The system of claim 12, further comprising:
one or more system management components coupled to the OLT via one or more backhaul networks,
wherein the OLT is configured to notify the one or more system management components regarding the alert,
wherein the notification includes at least the location of the ONU and associated distribution fiber.

18. The system of claim 17,
wherein the one or more system management components are configured to generate a notification to one or more field personnel devices regarding the alert.

19. A non-transitory computer readable medium comprising instructions, the instructions comprising:
one or more instructions that, when executed by one or more processors, cause the one or more processors to:
establish at least one data channel between an optical line terminal (OLT) and at least one optical network unit (ONU),
receive a live data traffic signal on at least one of the at least one data channel;
monitor the live data traffic signal for one or more abnormalities; and
transmit an alert to the OLT when one or more abnormalities is detected.

20. The non-transitory computer readable medium of claim 19, wherein the one or more abnormalities comprise at least one of a state of polarization or a phase variation of the sensing signal.
